(19) United States
(12) Patent Application Publication
(10) Pub. No.: US 2016/0267452 A1
(43) Pub. Date: Sep. 15, 2016

(54) SETTLEMENT SYSTEM AND METHOD FOR OVERSEAS PURCHASE PAYMENT

(71) Applicant: NHN Entertainment Corporation, Seongnam-si (KR)

(72) Inventor: Yeon-Hwa KIM, Seongnam-si (KR)

(21) Appl. No.: 15/065,452

(22) Filed: Mar. 9, 2016

(30) Foreign Application Priority Data
Mar. 15, 2015 (KR) 10-2015-0033827

(51) Int. Cl. G06Q 20/12; G06Q 20/38

(52) U.S. Cl. CPC G06Q 20/12; G06Q 20/381

(57) ABSTRACT

A payment settlement platform server includes a transaction information receiving module for receiving first transaction information including a first payment amount and second transaction information including a second payment amount from a first and second payment server, respectively. The first payment server and the second payment server, respectively, belong a first payment agency of a first country and a second payment agency of a second country. A payment settlement information generating module generates settlement information including a balance between the first payment amount and the second payment amount based on the first and second transaction information, wherein the balance is calculated based on an exchange rate between a first currency and a second currency. A settlement information transmitting module transmits the first transaction information and the settlement information to the first payment server and transmitting the second transaction information and the settlement information to the second payment server.

### CROSS REFERENCE TO RELATED APPLICATION

This application claims priority from and the benefit of Korean Patent Application No. 10-2015-0033827, filed on Mar. 11, 2015, which is hereby incorporated by reference for all purposes as if fully set forth herein.

### BACKGROUND

1. Field

Exemplary embodiments relate to a payment settlement system for an overseas on-line purchase payment. More particularly, exemplary embodiments relate to a payment settlement system facilitating an overseas purchase through network communication with reductions in hidden-costs, i.e., credit card fees, currency exchange fees, etc., caused by an overseas transaction.

2. Discussion of the Background

Generally, when a purchaser purchases merchandise from an on-line mall operated by a foreign sales entity and pays in credit card, the payment amount is charged through a credit card issuer via an international payment network entity, for example VISA, MasterCard, etc.

However, the currency accepted by the on-line mall may be different from the currency of the nation of the card issuer. In this case, the purchaser may bear hidden costs associated with payment for an overseas purchase, such as currency exchange fees, fees for using the international payment network, unexpected foreign-exchange losses caused by a difference between the purchase date and a payment settlement date.

Also, since most commercial on-line malls provide prices of products to sell in a specific currency they accept for payment, generally in a currency that the nation of the on-line mall issues, a foreign purchaser experiences inconveniences associated with payment by credit card. Recently, for solving these problems, a dynamic currency conversion (DCC) payment service has been introduced, which allows a purchaser to pay in his or her country's currency for an overseas purchase. However, the purchasers who use the DCC service must also bear a service fee, generally 3-8% of the purchase amount, whether or not they recognized they are paying service fee.

Referring to FIGS. 1A and 1B, conventional payment methods will be described in detail.

FIG. 1A is a block diagram of a system for an overseas on-line purchase.

Referring to FIG. 1A, according to a conventional payment method for an overseas purchase, when a purchaser buys merchandise at a foreign on-line mall, the merchandise is priced in a currency of the country of the on-line mall, and payment for the merchandise will be paid in the same currency. In this case, credit cards available for such an overseas transaction may be VISA (Visa®), MASTER (MasterCard®), and AMEX (American Express®). VISA and MASTER charge an overseas transaction fee of 1% of the payment amount per transaction, and AMEX charges 1.4% per overseas transaction. In addition, card issuers of the credit card used by the purchaser for payment will charge their service fee of which rate is 0.18-0.35% of the payment amount per transaction. Therefore, the purchaser will pay a service charge for an overseas purchase payment service of 1.18-1.75% of purchase price for each transaction. Also, since, in most cases, it takes few days for settlement between credit card issuers and an overseas payment agency after approval of credit card payment, the purchaser may bear a foreign-exchange loss caused by changes in the exchange rate when exchange rate changes between the date of approval of credit card payment and settlement of the payment between credit card issuers and the overseas payment agency.

Recently, a payment service has been introduced which provides the purchase price of merchandise in a currency of the purchaser's country and allows payment in the currency of the purchaser's country. According to such service, when a foreign purchaser accesses an on-line mall, prices of goods and services are automatically modified to be in the currency of the purchaser's country and displayed as such on the purchaser's device.

Most purchasers will proceed with payment for the price displayed on their device without knowing that an extra service fee of 3-8% of the actual price of the goods is being charged.

More specifically, referring to FIG. 1B, if a purchaser pays for the purchase of goods in a currency of the purchaser's country, the payment will be exchanged from the currency of the purchaser's country to a currency the merchant's country to be paid the merchant and then will be exchanged from the currency of the merchant's country to the currency of the purchaser's country to be paid the card issuer, so that the purchaser bears the cost caused by the two step exchange. However, because of convenience, the purchaser who does not know about the complicated procedure unknowingly pays the service charge up to 8% of the total purchase price.

As described above, when a purchaser buy goods and services from overseas on-line mall, the purchaser may bear excessive service fees for the payments, and the more the purchaser buys through an overseas on-line mall, the more service fees the purchaser will bear.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a payment settlement system facilitating an overseas purchase through network communication with a reduction in hidden-costs caused by the overseas transaction.

Additional aspects will be set forth in the detailed description which follows, and, in part, will be apparent from the disclosure, or may be learned by practice of the inventive concept.

An exemplary embodiment discloses a system for settling payment for overseas purchases comprising a first user device, a second user device, a first sales server, a second sales server, a first payment server, a second payment server, and a payment settlement platform server. The first sales server provides, in response to a second purchase order received from the second user device, a second payment amount in the second country's currency for the second user device, and generates a second payment request including the second payment amount. The second sales server provides, in response to a first order received from the first user device, a first payment amount in the first country's currency for the first device, and generates a first payment request including the first payment amount. The first payment server of the first country receives the first payment request from the second sales server and generates a first transaction information including at least the first payment amount. The second payment server of the second country receives the second payment request from the first sales server and generates a second transaction information including at least the second payment amount. The payment settlement platform server receives the first and second transaction information, respectively, from first the and second payment server, generates a balance information including balance between the first payment amount and second payment amount, transmits the second transaction information and the balance information to the first payment server, and transmits the first transaction and the balance information to the second payment server. The balance information is calculated based on a currency exchange rate between the first country's currency and the second country's currency. The first payment server charges the first user device for the first payment amount in the first country's currency using the first transaction information and pays the first sales server the second payment in the first country's currency using the second transaction information received from the payment settlement server. The second payment server charges the second user device for the second payment amount in the second country's currency using the second transaction information and pays the second sales server the first payment in the second country's currency using the first transaction information received from the payment settlement server. The first payment server and second payment server settle the balance through the payment settlement platform server.

According to another exemplary embodiment, the first payment server of the first country receives the second payment request from the first sales server and generates a second transaction information including at least the second payment amount. The second payment server of the second country receives the first payment request from the second sales server and generates a first transaction information including at least the first payment amount. The payment settlement platform server receives the first and second transaction information, respectively, from the second and first payment server, generates a balance information including balance, transmits the first transaction information and the balance information to the first payment server, and transmits the second transaction and the balance information to the second payment server. The balance information is calculated based on a currency exchange rate between the first payment amount and second payment amount between the first country's currency and the second country's currency. The first payment server charges the first user device for the first payment amount in the first country's currency using the first transaction information received from the payment settlement server and pays the first sales server the second payment in the first country's currency using the second transaction information. The second payment server charges the second user device for the second payment amount in the second country's currency using the second transaction information received from the payment settlement server and pays the second sales server the first payment in the second country's currency using the first transaction information. The first payment server and second payment server settle the balance through the payment settlement platform server.

According to another exemplary embodiment, the first sales server provides, in response to a second purchase order received from the second user device, a second payment amount in the second country's currency for the second user device. The second sales server provides, in response to a first order received from the first user device, a first payment amount in the first country's currency for the first device. The first payment server of the first country charges the first user device for a first payment amount in the first country's currency in response to a first payment request, including the first payment amount, transmitted from the first user device, and generates a first transaction information including at least the first payment amount. The second payment server of the second country charges the second user device for a second payment amount in the second country's currency in response to a second payment request, including the second payment amount, transmitted from the first user device and generates a second transaction information including at least the second payment amount. The payment settlement platform server receives the first and second transaction information, respectively, from first the and second payment server, generates a balance information including balance between the first payment amount and second payment amount, transmits the second transaction information and the balance information to the first payment server, and transmits the first transaction and the balance information to the second payment server. The balance information is calculated based on a currency exchange rate between the first country's currency and the second country's currency. The first payment server pays the first sales server the second payment in the first country's currency using the second transaction information received from the payment settlement server. The second payment server pays the second sales server the first payment in the second country's currency using the first transaction information received from the payment settlement server. The first payment server and second payment server settle the balance through the payment settlement platform server.

An exemplary embodiment discloses a payment settlement platform server including a receiving module for receiving first transaction information including a first payment amount and second transaction information including a second payment amount from a first payment server and a second payment server, respectively. The first payment server and the second payment server, respectively, belong to a first payment agency of a first country and a second payment agency of a second country. A payment settlement module generates settlement information including a balance between the first payment amount and the second payment amount based on the first and second transaction information, wherein the balance is calculated based on an exchange rate between a first currency and a second currency. A transmitting module transmits the first transaction information and the settlement information to the first payment server and transmitting the second transaction information and the settlement information to the second payment server.

According to an exemplary embodiment, the first payment amount may correspond a price of a first product, the first product purchased from a second sales server using the second currency by a first user device using the first currency, and the first payment amount is requested, by the second sales server, to be approved by the second payment server. Also, the second payment amount may correspond a price of a second product, the second product is purchased from a first sales server using the first currency by a second user device using the second currency, and the second payment amount is requested, by the first sales server, to be approved by the first payment server.

According to another exemplary embodiment, a payment settlement platform server includes a receiving module for receiving first transaction information including a first payment amount and second transaction information including a second payment amount from a first payment server and a second payment server, respectively. The first payment server and the second payment server, respectively, belong to a first payment agency of a first country and a second payment agency of a second country. A payment settlement module generates settlement information including a balance between the first payment amount and the second payment amount based on the first and second transaction information, wherein the balance is calculated based on an exchange rate between a first currency and a second currency. A transmitting module transmits the first transaction information and the settlement information to the second payment server and transmitting the second transaction information and the settlement information to the first payment server. The first payment amount may correspond to a price of a first product, the first product purchased from a second sales server using the second currency by a first user device using the first currency, and the first payment amount is requested, by the second sales server, to be approved by the first payment server. Also, the second payment amount may correspond to a price of a second product, the second product purchased from a first sales server using the first currency by a second user device using the second currency, and the second payment amount is requested, by the first sales server, to be approved by the second payment server.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIGS. 1A and 1B are block diagrams of conventional systems for an overseas on-line purchase.

FIG. 2 is a block diagram illustrating a system for settling payment for overseas purchases according to a first exemplary embodiment.

FIG. 3 is a flow chart illustrating a method for payment settlement of overseas purchases using a payment settlement system according to the first exemplary embodiment.

FIG. 4 is a block diagram illustrating a payment settlement system for overseas purchases according to a second exemplary embodiment.

FIG. 5 is a flow chart illustrating a payment settlement system for overseas purchases using a payment settlement system according to a second exemplary embodiment.

FIG. 6 is a block diagram illustrating a payment settlement system for overseas purchases according to a third exemplary embodiment.

FIG. 7 is a flow chart illustrating a payment settlement system for overseas purchases using a payment settlement system according to a third exemplary embodiment.

FIG. 8 is a block diagram illustrating a payment settlement platform server according to an exemplary embodiment.

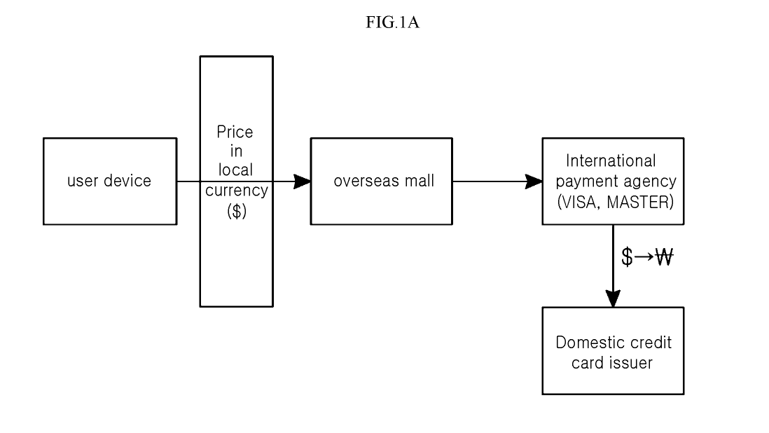

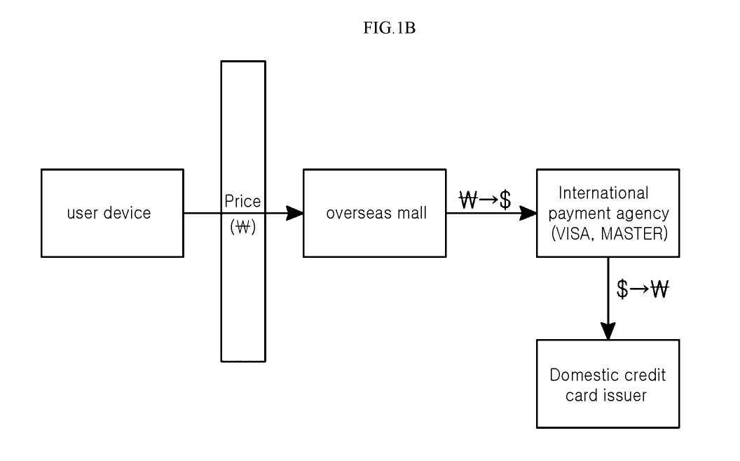

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of regions, etc., may be exaggerated for clarity and descriptive purposes. Also, like reference numerals denote like elements.

When an element is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element or layer, there are no intervening elements present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, and/or sections, these elements, components, regions, and/or sections should not be limited by these terms. These terms are used to distinguish one element, component, region, and/or section from another element, component, region, and/or section. Thus, a first element, component, region, and/or section discussed below could be termed a second element, component, region, and/or section without departing from the teachings of the present disclosure.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, the payment settlement system for an overseas on-line purchase payment and method according to exemplary embodiments will be described in detail.

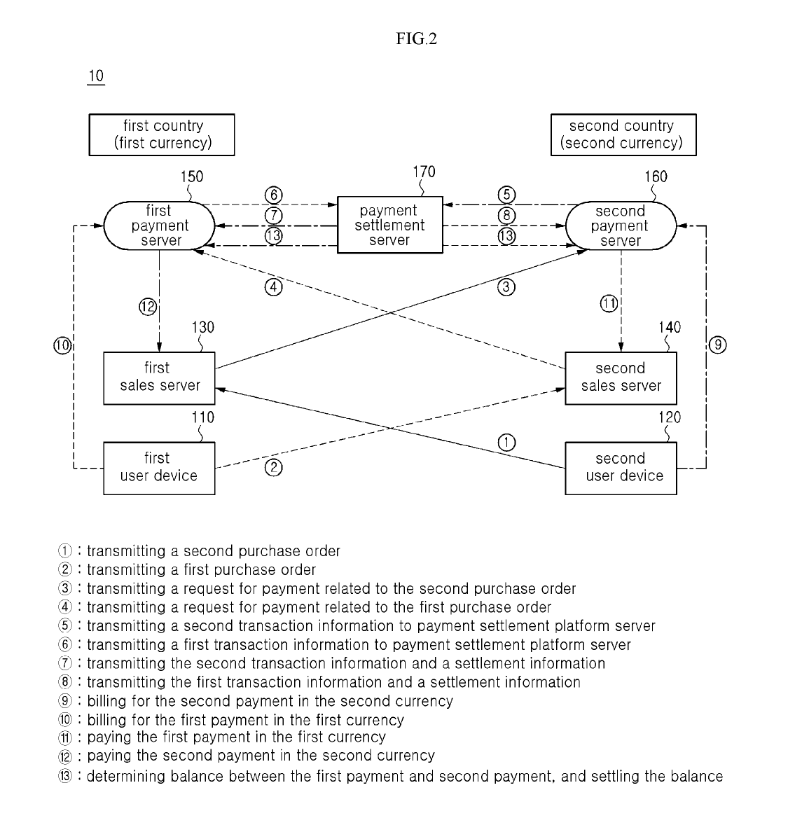

FIG. 2 is a block diagram illustrating a system for settling payment for overseas purchases according to a first exemplary embodiment.

Referring to FIG. 2, a first exemplary embodiment of payment settlement system 10 comprises a first user device 110, a second user device 120, a first sales server 130, a second sales server 140, a first payment server 150, a second payment server 160, and a payment settlement platform server 170.

The first user device 110 is a digital device, such as a smartphone, tablet PC, and personal digital assistant (PDA), may include a touch panel display, and is capable of communicating with other digital device via a communication network. The first user device 110 belongs to a first user of a first country using a first currency. On the other hand, the second user device 120 is a digital device belonging to a second user of a second country using a second currency.

Each of the first sales server 130 and second sales server 140 is an on-line commercial server operated, respectively, by a first sales entity of the first country and a second sales entity of the second country. The first sales server 130 is configured to receive a second purchase order for second product from the second user device 120 via a communication network. Also, the first sales server 130 is configured to convert a price of the second product in first currency into a converted price in the second currency, and to provide the second converted price with the second user device 120. The first sales server 130 is further configured to generate, in response to the second purchase order, a second payment request for the second converted price (as a second payment amount) and to transmit the second payment request to the second payment server 160. On the other hand, the second sales server 140 is configured to receive a first purchase order for first product from the first user device 110 via a communication network. Also, the second sales server 140 is configured to convert a price of the first product in second currency into a first converted price in the first currency and to provide the first converted price with the first user device 120. The second sales server 140 is further configured to generate, in response to the first purchase order, a first payment request for the first converted price (as a first payment amount) and to transmit the first payment request to the first payment server 150.

Each of the first payment server 150 and second payment server 160 is an on-line payment service operated, respectively, by a first local (or domestic) payment agency in the first country and a second local (or domestic) payment agency in the second country. The first payment server 150 is configured to receive the first payment request from the second sales server 140, to generate a first transaction information including at least the first payment amount, and to transmit the first transaction information to the payment settlement platform server 170. The second payment server 160 is configured to receive the second payment request from the first sales server 130, to generate a second transaction information including at least the second payment amount, and to transmit the second transaction information to the payment settlement platform server 170.

The payment settlement platform server 170 is configured to receive the first transaction information and the second transaction information, respectively, from the first payment server 150 and the second payment server 160. Further, the payment settlement platform server 170 is configured to generate a settlement information including balance between the first payment amount and second payment amount. The balance is calculated based on an exchange rate between the first currency and the second currency. In addition, the payment settlement platform server 170 is configured to transmit the first transaction information and the balance information to the second payment server 160 and to transmit the second transaction information and the balance information to the first payment server 150.

More specifically, in response to a purchase order for a first merchandise from the first user device 110, the second sales server 140 converts a first price of the first merchandise into a currency of the first customer's country (“first currency” hereinafter), provides the converted first price for the first user device 110, and then transmits to a first payment server 150 a request for approving payment of the converted first price of the merchandise. On the other hand, in response to a purchase order for a second merchandise from the second user device 120, the first sales server 130 converts a second price of the second merchandise into a currency of the second customer's country (“second currency” hereinafter), provides the converted second price for the second user device 120, and then transmits to a second payment server 160 a request for approving payment of the converted second price of the merchandise.

The first payment server 150 transmits a first transaction information including at least the converted first price to a payment settlement platform server 170, and the second payment server 160 transmits a second transaction information including at least the converted second price to the payment settlement platform server 170.

The payment settlement platform server 170 receives the first transaction information and second transaction information from the first payment server 150 and second payment server 160 respectively, and generates a balance information including balance between the converted first price and the converted second price which is calculated based on exchange rate between the first currency and second currency. The payment settlement platform server 170, then transmits the second transaction information and balance information to the first payment server 150 and transmits the first transaction information and balance information to the second payment server 160.

The first payment server 150, using the first transaction information, charges the first customer for the converted first price by the first currency and pays the first sales server 130 for the second price by the first currency using the second transaction information received from the payment settlement platform server 170.

The second payment server 160, using the second transaction information, charges the second customer for the converted second price by the second currency and pays the second sales server 140 for the first price by the second currency using the first transaction information received from the payment settlement platform server 170.

Finally, the first payment server 150 and second payment server 160 settle the balance through the payment settlement platform server 170.

For example, a first user in Korea (a first purchaser) buys a first merchandise of which price is 1 USD (a second currency) from an on-line mall of a sales entity in US (a second sales server's operator), a second user in US (a second purchaser) buys a second merchandise of which price is 1,000 KRW (a first currency) from an on-line mall of a sales entity in Korea (a first sales server's operator) and exchange rate between USD and KRW is 1,000, i.e., 1,000 KRW equals 1 USD. In this case, a first sales server 130 of the first sales entity in Korea converts the price of the second merchandise 1,000 KRW into 1 USD based on the exchange rate and provides the converted price 1 USD for the second user in the US. Then, the first sales server 130 of the first sales entity in Korea transmits a request for approval of payment of 1 USD (second payment request) to a second payment server 160 of a payment agency in US, e.g., a US card issuer. On the other hand, the second sales server 140 of the second sales entity in US converts the price of the first merchandise 1 USD into 1,000 KRW based on the exchange rate and provides the converted price 1,000 KRW for the first user in Korea. Also, then, the second sales server 140 if the second sales entity in US transmits a request for approval of payment of 1,000 KRW (first payment request) to a first payment server 150 of a payment agency in Korea, e.g., a Korean card issuer.

The first payment server 150 of a payment agency in Korea receives the first payment request of 1,000 KRW and transmits the first payment request of 1,000 KRW to the payment settlement platform server 170 and the second payment server 160 of the payment agency in the US receives the second payment request of 1 USD and transmits the second payment request of 1 USD to the payment settlement platform server 170. Then, the payment settlement platform server 170 generates a balance information including balance between 1,000 KRW and 1 USD, each of which has been received from the first payment server 150 and second payment server 160 respectively, based on the exchange rate. In the above case, the balance is 0 USD and 0 KRW. The first payment server 150 of the first payment agency in Korea charges the first user in Korea for 1,000 KRW, which is a price of the first merchandise in Korean currency, according to the first payment request and pays the second price 1,000 KRW, which is a price of the second merchandise in Korean currency, to the first sales entity in Korea according to the second payment request. Similarly, the second payment server 160 of the second payment agency in the US charges the second user in the US for 1 USD, which is a price of the second merchandise in US currency, according to the second payment request and pays the first price 1 USD, which is a price of the first merchandise in US currency, to the second sales entity in the US according to the first payment request. Finally, the first and second payment server 150 and 160 settle the balance, if any, through the payment settlement platform server 170 according to the balance information. In the above case, the balance is zero, so that no settlement is required. If the Korean user buys a first item with a price of 2 USD from the US sales entity and the US user buys a second item with a price of 1,000 KRW from the Korean sales entity in the above case, the balance is 1 USD. Therefore, the first payment agency in Korea charges the Korean user for 2,000 KRW, which is converted from 2 USD into based on the above exchange rate, for the first item and pays 1,000 KRW for the second item to the Korean sales entity, and the second payment agency in the US charges the US user for 1 USD, which is converted from 1,000 KRW into based on the above exchange rate, for the second item and pays 2 USD for the first item to the US sales entity. Then, the Korean payment agency will pay the balance of 1 USD to the US payment agency to settle the overall payment procedure.

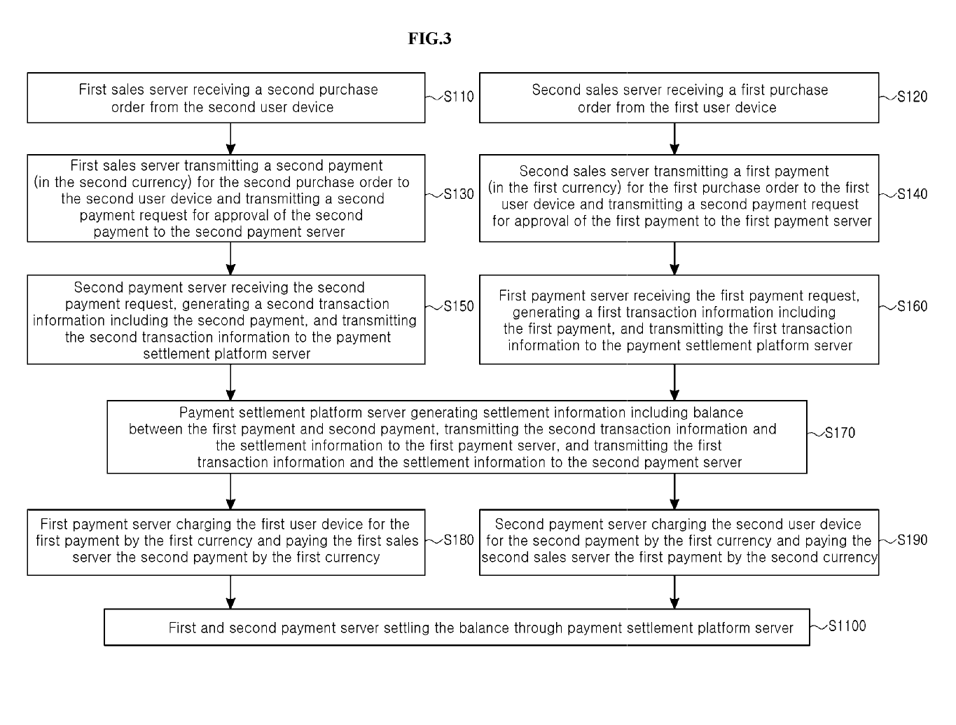

FIG. 3 is a flow chart illustrating a method for payment settlement of overseas purchases using a payment settlement system according to the first exemplary embodiment.

First, the sales server 130 receives a second purchase order from the second user device 120 S110, and the second sales server 140 receiving a first purchase order from the first user device 110 S120. The first sales server 130 converts a price of the second product in first currency into a converted price in the second currency to provide to the second user device 120, generates, in response to the second purchase order, a second payment request for the second converted price (as a second payment amount), and transmits the second payment request to the second payment server 160 S130. The second sales server 140 converts a first price of the first product in second currency into a first converted price in the first currency to provide to the first user device 120, generates, in response to the first purchase order, a first payment request for the first converted price (as a first payment amount), and transmits the first payment request to the first payment server 150 S140. Then, the first payment server 150 receives the first payment request from the second sales server 140, generates a first transaction information including at least the first payment amount, and transmits the first transaction information to the payment settlement platform server 170 S150. The second payment server 160 receives the second payment request from the first sales server 130, generates a second transaction information including at least the second payment amount, and transmits the second transaction information to the payment settlement platform server 170 S160. The payment settlement platform server 170 generates a settlement information including balance between the first payment amount and second payment amount based on the received first and second transaction information, transmits the second transaction information and the settlement information to the first payment server 150, and transmits the first transaction information and the settlement information to the second payment server 160 S170. The balance is calculated based on an exchange rate between the first currency and the second currency. The first payment server 150 charges, using the first transaction information, the first user device 110 for the first payment in the first currency and pays the first sales server 130 the second payment in the first currency using the second transaction information S180. The second payment server 160 charges, using the second transaction information, the second user device 120 for the second payment in the first currency and pays the second sales server 140 the first payment in the second currency S190. Lastly, the first and second payment server 150 and 160 settle the balance through payment settlement platform server 170 S1100.

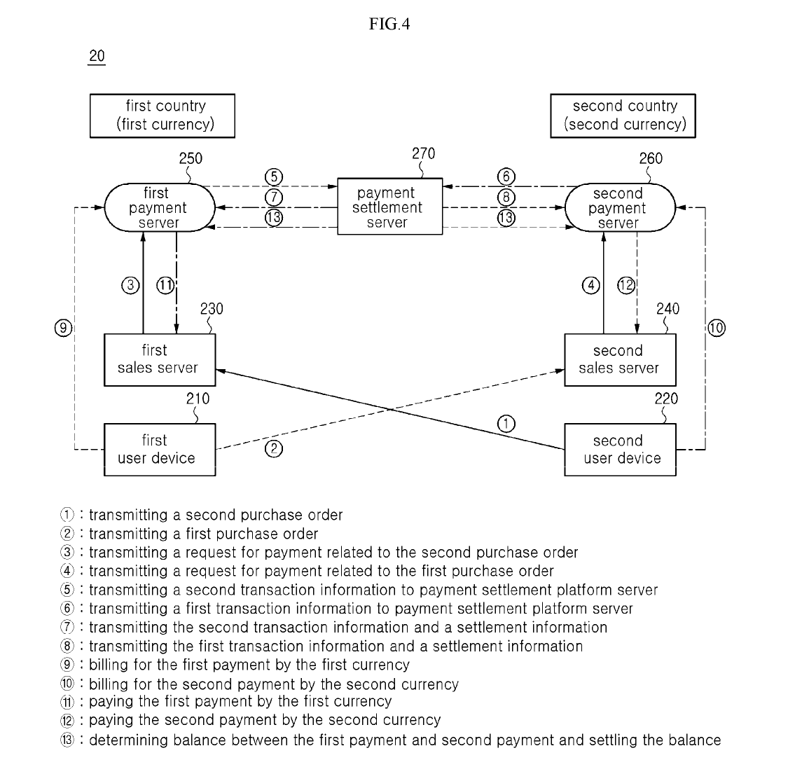

FIG. 4 is a block diagram illustrating a payment settlement system for overseas purchases according to a second exemplary embodiment.

Referring to FIG. 4, a second exemplary embodiment of payment settlement system 20 comprises a first user device 210, a second user device 220, a first sales server 230, a second sales server 240, a first payment server 250, a second payment server 260, and a payment settlement platform server 270.

The first user device 210 is a digital device, such as a smartphone, tablet PC, and personal digital assistant (PDA), may include a touch panel display, and is capable of communicating with other digital device via a communication network. The first user device 210 belongs to a first user of a first country using a first currency. On the other hand, the second user device 220 is a digital device belonging to a second user of a second country using a second currency.

Each of the first sales server 230 and second sales server 240 is an on-line commercial server operated, respectively, by a first sales entity of the first country and a second sales entity of the second country. The first sales server 230 is configured to receive a second purchase order for second product from the second user device 220 via a communication network. Also, the first sales server 230 is configured to convert a price of the second product in first currency into a converted price in the second currency and to provide the second converted price with the second user device 220. The first sales server 230 is further configured to generate, in response to the second purchase order, a second payment request for the second converted price (as a second payment amount) and to transmit the second payment request to the first payment server 250. On the other hand, the second sales server 240 is configured to receive a first purchase order for first product from the first user device 210 via a communication network. Also, the second sales server 240 is configured to convert a price of the first product in second currency into a first converted price in the first currency and to provide the first converted price with the first user device 220. The second sales server 240 is further configured to generate, in response to the first purchase order, a first payment request for the first converted price (as a first payment amount) and to transmit the first payment request to the second payment server 260.

Each of the first payment server 250 and second payment server 260 is an on-line payment service operated, respectively, by a first local (or domestic) payment agency in the first country and a second local (or domestic) payment agency in the second country. The first payment server 250 is configured to receive the second payment request from the first sales server 230, to generate a second transaction information including at least the second payment amount, and to transmit the second transaction information to the payment settlement platform server 270. The second payment server 260 is configured to receive the first payment request from the second sales server 240, to generate a first transaction information including at least the first payment amount, and to transmit the first transaction information to the payment settlement platform server 270.

The payment settlement platform server 270 is configured to receive the first transaction information and the second transaction information, respectively, from the second payment server 260 and the first payment server 250. Further, the payment settlement platform server 270 is configured to generate a settlement information including a balance between the first payment amount and second payment amount. The balance is calculated based on an exchange rate between the first currency and the second currency. In addition, the payment settlement platform server 270 is configured to transmit the first transaction information and the balance information to the first payment server 250 and to transmit the second transaction information and the balance information to the second payment server 260.

More specifically, when a first user device 210 transmits a purchase order for a first item to a second sales server 240, the second sales server 240 converts a first price of the first item into a converted first price in a first currency and provides the converted first price for the first user device 210. Then the second sales server 240 transmits a first payment request including the converted first price to a second payment server 260. On the other hand, when a second user device 220 transmits a purchase order for a second item to a first sales server 230, the first sales server 230 converts a second price of the second item into a converted second price in a second currency and provides the converted second price for the second user device 220. Then the first sales server 230 transmits a second payment request including the converted second price to a first payment server 250.

Then, the first payment server 250 generates a second transaction information including at least the converted second price and transmitting the second transaction information to the payment settlement platform server 270. Also, the second payment server 260 generates a first transaction information including at least the converted first price and transmits the first transaction information to the payment settlement platform server 270.

The payment settlement platform server 270 receives the first transaction information and second transaction information from the second payment server 260 and first payment server 250 respectively, and generates a balance information including balance between the converted first price and the converted second price which is calculated based on exchange rate between the first currency and second currency. The payment settlement platform server 270 then transmits the first transaction information and balance information to the first payment server 250, and transmits the second transaction information and balance information to the second payment server 260.

The first payment server 250, using the first transaction information received from the payment settlement platform server 270, charges the first customer for the converted first price by the first currency and pays the first sales server 230 for the second price by the first currency using the second transaction information.

The second payment server 260, using the second transaction information received from the payment settlement platform server 270, charges the second customer for the converted second price by the second currency and pays the second sales server 240 for the first price by the second currency using the first transaction information.

Finally, the first payment server 250 and second payment server 260 settle the balance through the payment settlement platform server 270.

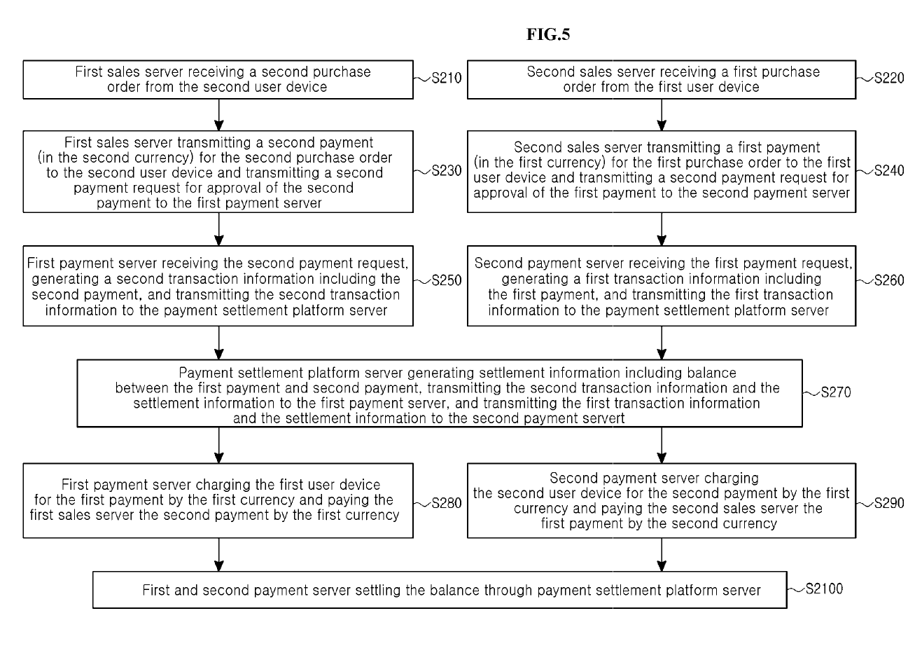

FIG. 5 is a flow chart illustrating a payment settlement system for overseas purchases according to a second exemplary embodiment.

First, the sales server 230 receives a second purchase order from the second user device 220 S210, and the second sales server 240 receiving a first purchase order from the first user device 210 S220. The first sales server 230 converts a price of the second product in first currency into a converted price in the second currency to provide with the second user device 220, generates, in response to the second purchase order, a second payment request for the second converted price (as a second payment amount), and transmits the second payment request to the first payment server 250 S230. The second sales server 240 converts a first price of the first product in second currency into a first converted price in the first currency to provide with the first user device 220, generates, in response to the first purchase order, a first payment request for the first converted price (as a first payment amount), and transmits the first payment request to the second payment server 260 S240. Then, the first payment server 250 receives the second payment request from the first sales server 230, generates a second transaction information including at least the second payment amount, and transmits the second transaction information to the payment settlement platform server 270 S250. The second payment server 260 receives the first payment request from the second sales server 240, generates a first transaction information including at least the first payment amount, and transmits the first transaction information to the payment settlement platform server 270 S260. The payment settlement platform server 270 generates a settlement information including balance between the first payment amount and second payment amount based on the received first and second transaction information, transmits the first transaction information and the settlement information to the first payment server 250, and transmits the second transaction information and the settlement information to the second payment server 260 S270. The balance is calculated based on an exchange rate between the first currency and the second currency. The first payment server 250 charges, using the first transaction information, the first user device 210 for the first payment in the first currency and pays the first sales server 230 the second payment in the first currency using the second transaction information S280. The second payment server 260 charges, using the second transaction information, the second user device 220 for the second payment in the first currency and pays the second sales server 240 the first payment in the second currency S290. Lastly, the first and second payment server 250 and 260 settle the balance through payment settlement platform server 270 S1100.

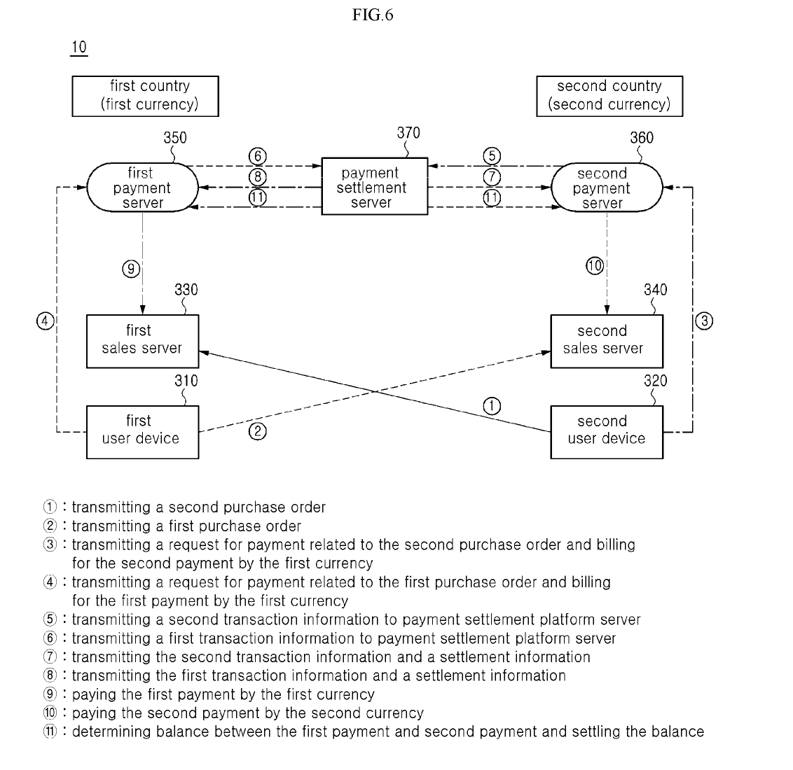

FIG. 6 is a block diagram illustrating a payment settlement system for overseas purchases according to a third exemplary embodiment.

Referring to FIG. 6, a third exemplary embodiment of payment settlement system 30 comprises a first user device 310, a second user device 320, a first sales server 330, a second sales server 340, a first payment server 350, a second payment server 360, and a payment settlement platform server 370.

The first user device 310 is a digital device, such as a smartphone, tablet PC, and personal digital assistant (PDA), may include a touch panel display, and is capable of communicating with other digital device via a communication network. The first user device 310 belongs to a first user of a first country using a first currency. On the other hand, the second user device 320 is a digital device belonging to a second user of a second country using a second currency.

Each of the first sales server 330 and second sales server 340 is an on-line commercial server operated, respectively, by a first sales entity of the first country and a second sales entity of the second country. The first sales server 330 is configured to receive a second purchase order for second product from the second user device 320 via a communication network. Also, the first sales server 330 is configured to convert a price of the second product in first currency into a converted price in the second currency and to provide the second converted price with the second user device 320. On the other hand, the second sales server 340 is configured to receive a first purchase order for first product from the first user device 310 via a communication network. Also, the second sales server 340 is configured to convert a price of the first product in second currency into a first converted price in the first currency and to provide the first converted price with the first user device 320.

Each of the first payment server 350 and second payment server 360 is an on-line payment service operated, respectively, by a first local (or domestic) payment agency in the first country and a second local (or domestic) payment agency in the second country. The first payment server 350 is configured to receive the first payment request from the first user device 310, to generate a first transaction information including at least the first payment amount, and to transmit the first transaction information to the payment settlement platform server 370. The second payment server 360 is configured to receive the second payment request from the second user device 320, to generate a second transaction information including at least the second payment amount, and to transmit the second transaction information to the payment settlement platform server 370.

The payment settlement platform server 370 is configured to receive the first transaction information and the second transaction information, respectively, from the first payment server 350 and the second payment server 360. Further, the payment settlement platform server 370 is configured to generate a settlement information including balance between the first payment amount and second payment amount. The balance is calculated based on an exchange rate between the first currency and the second currency. In addition, the payment settlement platform server 370 is configured to transmit the first transaction information and the balance information to the second payment server 360 and to transmit the second transaction information and the balance information to the first payment server 350.

More specifically, when a first user device 310 transmits a purchase order for a first item to a second sales server 340, the second sales server 340 converts a first price of the first item into a converted first price in a first currency and provides the converted first price for the first user device 310. On the other hand, when a second user device 320 transmits a purchase order for a second item to a first sales server 330, the first sales server 330 converts a second price of the second item into a converted second price in a second currency and provides the converted second price for the second user device 320.

Then the first user device 310 transmits a first payment request including at least the converted first price to a first payment server 350, and the second user device 320 transmits a second payment request including at least the converted second price to a second payment server 360.

The first payment server 350 charges, in response to the first payment request, the first user device 310 for the first payment request in the first currency, generates a first transaction information including at least the converted first price, and transmits the first transaction information to the payment settlement platform server 370. On the other hand, the second payment server 360 charges, in response to the second payment request, the second user device 320 for the second payment request in the second currency, generates a second transaction information including at least the converted second price, and transmits the second transaction information to the payment settlement platform server 370.

The payment settlement platform server 370 receives the first transaction information and second transaction information from the first payment server 350 and second payment server 360 respectively, and generates a balance information including balance between the converted first price and the converted second price which is calculated based on exchange rate between the first currency and second currency. The payment settlement platform server 370 then transmits the second transaction information and balance information to the first payment server 350 and transmits the first transaction information and balance information to the second payment server 360. The first payment server 350 pays the first sales server 330 the second price by the first currency using the second transaction information received from the payment settlement platform server 370. Also, the second payment server 360 pays the second sales server 340 the first price by the first currency using the first transaction information received from the payment settlement platform server 370.

Then the first payment server 350 and second payment server 360 settle the balance through the payment settlement platform server 370.

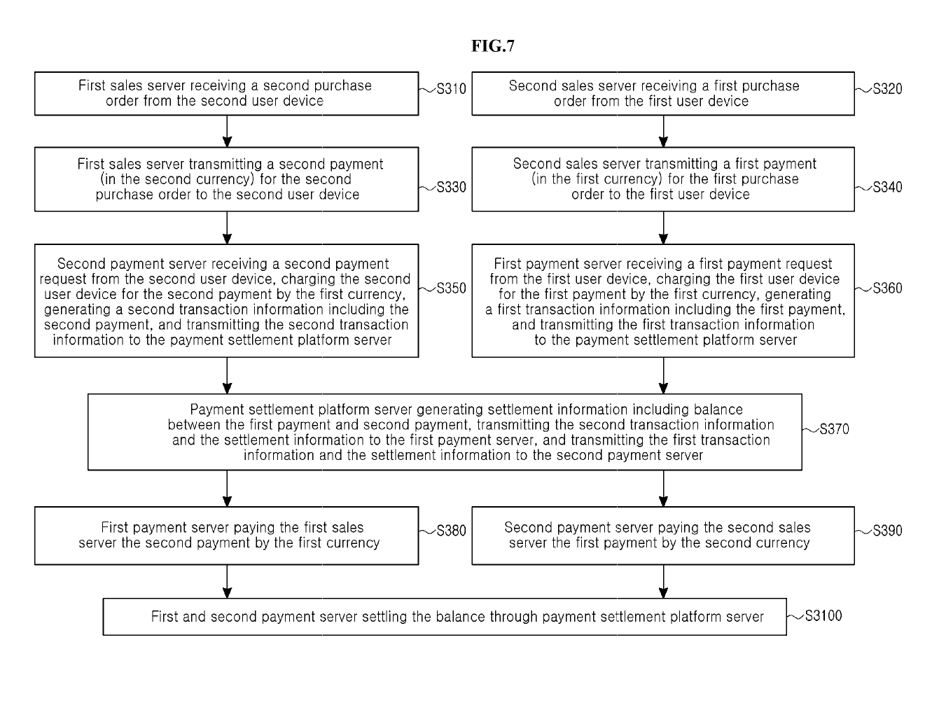

FIG. 7 is a flow chart illustrating a payment settlement system for overseas purchases using a payment settlement system according to a third exemplary embodiment.

The first sales server 330 receives a second purchase order for second product from the second user device 320 S310. The second sales server 340 is configured to receive a first purchase order for first product from the first user device 310 S320. The first sales server 330 is converts a price of the second product in first currency into a converted price in the second currency and provides the second converted price with the second user device 320 S330. The second sales server 340 converts a price of the first product in second currency into a first converted price in the first currency and provides the first converted price with the first user device 310 S340. The second payment server 370 receives a second payment request from the second user device 320, charges the second user device 320 for the second payment by the first currency, generates a second transaction information including the second payment, and transmits the second transaction information to the payment settlement platform server 370 S350. The First payment server 370 receives a first payment request from the first user device 310, charges the first user device 310 for the first payment by the first currency, generates a first transaction information including the first payment, and transmits the first transaction information to the payment settlement platform server 370 S360. The payment settlement platform server 370 generates settlement information including balance between the first payment and second payment based on the received first and second transaction information, transmits the second transaction information and the settlement information to the first payment server 350, and transmits the first transaction information and the settlement information to the second payment server 360 S370. The balance is calculated based on an exchange rate between the first currency and the second currency. The first payment server 350 pays the first sales server 330 the second payment in the first currency using the second transaction information S380. The second payment server 360 pays the second sales server 340 the first payment in the second currency S390. Lastly, the first and second payment server 350 and 360 settle the balance through payment settlement platform server 370 S3100.

While the above examples describe cases where one purchaser and one merchant for each country are involved in oversea purchase transaction, the payment settlement system according to the present invention may be used for multiple transactions between multiple purchasers and merchants. Also, the settlement of payment may be performed in real time, or periodically, for example, daily, weekly, or monthly.

It is noted that “first (second) user device of a first (second) country”, “first (second) sales server of a first (second) country” and “first (second) payment server of a first (second) country” are used for expressing what nationality they have and what currency they use, not for expressing where they are operated or where they perform functions. Therefore, each entity of a country may not be located in that country. Also, all entities of the first and second country may be located in a same country. For example, a first user may be a Korean national and may stay in the U.S. and purchase items using KRW, which is an official currency of Korea, from a U.S. online mall while staying in the U.S. Similarly, the first sales server and the first payment server may be located in second country even if the entities operating the first sales server and the first payment server have a nationality of the first country and use the first currency.

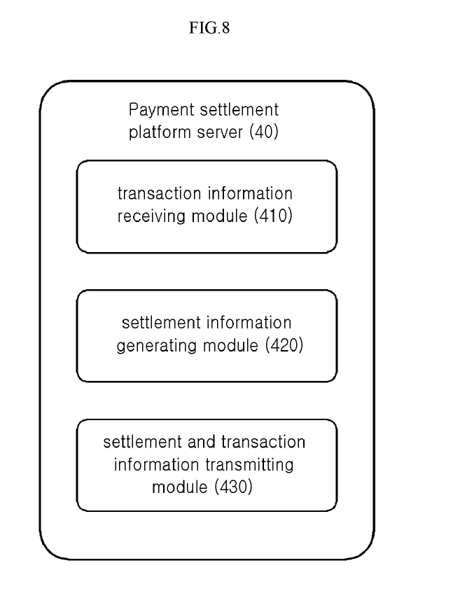

FIG. 8 is a block diagram illustrating a payment settlement platform server according to an exemplary embodiment.

The exemplary embodiment of payment settlement platform server 40 comprises a receiving module 410, a settlement information generating module 420, and a transmitting module 430. The receiving module 410 receives a first transaction information and second transaction information from the first payment server and second payment server. The settlement information generating module 420 calculates a balance between a first payment amount included in the first transaction information and second payment amount included in the second transaction information based on exchange rate between the first currency and second currency and generates a settlement information including the balance. The transmitting module 430 transmits the first transaction information and second transaction information to the second payment server and first payment server respectively with the settlement information.

For example, the first transaction information includes a first payment amount, wherein the first payment amount is the price, which is in a first currency of the first user's nation, of a product purchased from the second sales server by the first user device. And the second sales server sends a request to the first payment server for approval of the first payment amount in the first currency. The second transaction information includes a second payment amount, wherein the second payment amount is the price, which is in a second currency of the second user's nation, of product purchased from the first sales server by the second user device. And the first sales server request to the second payment server for approval of the second payment amount in the first currency.

In other example, the first transaction information includes a first payment amount, wherein the first payment amount is the price, which is in a first currency of the first user's nation, of product purchased from the second sales server by the first user device. And the second sales server sends a request to the second payment server for approval of the first payment amount in the first currency. The second transaction information includes a second payment amount, wherein the second payment amount is the price, which is in a second currency of the second user's nation, of product purchased from the first sales server by the second user device. And the first sales server sends a request to the first payment server for approval of the second payment amount in the first currency.

The above exemplary payment settlements system allow a purchaser using a first currency to pay overseas on-line mall using a second currency by the first currency to reduce various extra fees for overseas credit card payment.

In other word, a purchaser can buy a product from overseas on-line mall by his or her nation's currency without paying redundant currency exchange fees and international payment agency fees.

In exemplary embodiments, servers, modules, and/or one or more components thereof, may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like.

According to exemplary embodiments, the features, functions, processes, etc., described herein may be implemented via software, hardware (e.g., general processor, digital signal processing (DSP) chip, an application specific integrated circuit (ASIC), field programmable gate arrays (FPGAs), etc.), firmware, or a combination thereof. In this manner, servers, modules, and/or one or more components thereof may include or otherwise be associated with one or more memories (not shown) including code (e.g., instructions) configured to cause the server, module, and/or one or more components thereof to perform one or more of the features, functions, processes, etc., described herein.

The memories may be any medium that participates in providing code to the one or more software, hardware, and/or firmware components for execution. Such memories may be implemented in any suitable form, including, but not limited to, non-volatile media, and volatile media. Non-volatile media include, for example, optical or magnetic disks. Volatile media include dynamic memory. Common forms of computer-readable media include, for example, a floppy disk, a flexible disk, hard disk, magnetic tape, any other magnetic medium, a compact disk-read only memory (CD-ROM), a rewriteable compact disk (CDRW), a digital video disk (DVD), a rewriteable DVD (DVD-RW), any other optical medium, punch cards, paper tape, optical mark sheets, any other physical medium with patterns of holes or other optically recognizable indicia, a random-access memory (RAM), a programmable read only memory (PROM), and erasable programmable read only memory (EPROM), a FLASH-EPROM, any other memory chip or cartridge, a carrier wave, or any other medium from which information may be read by, for example, a controller/processor.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. A system for settling payment for overseas purchase, comprising:
a first user device of a first user using a first country's currency:
a second user device of a second user using a second country's currency:
a first sales server of the first country providing, in response to a second purchase order received from the second user device, a second payment amount in the second country's currency for the second user device, and generating a second payment request including the second payment amount;
a second sales server of the second country providing, in response to a first order received from the first user device, a first payment amount in the first country's currency for the first device, and generating a first confirmation request including the first payment amount;
a first payment server of the first country receiving the first payment request from the second sales server and generating a first transaction information including at least the first payment amount;
a second payment server of the second country receiving the second payment request from the first sales server and generating a second transaction information including at least the second payment amount; and
a payment settlement platform server receiving the first and second transaction information, respectively, from first the and second payment server, generating a balance information including balance between the first payment amount and second payment amount, transmitting the second transaction information and the balance information to the first payment server, and transmitting the first transaction and the balance information to the second payment server, wherein the balance information is calculated based on a currency exchange rate between the first country's currency and the second country's currency,
wherein the first payment server charges the first user device for the first payment amount in the first country's currency using the first transaction information and pays the first sales server the second payment in the first country's currency using the second transaction information received from the payment settlement platform server,
wherein the second payment server charges the second user device for the second payment amount in the second country's currency using the second transaction information and pays the second sales server the first payment in the second country's currency using the first transaction information from the payment settlement platform server, and
wherein the first payment server and second payment server settle the balance through the a payment settlement platform server.

2. A method for settling payment for overseas purchase, the method is performed by a network system comprising a first user device of a first country, a second user device of a second country, a first sales server of the first country, a second sales server of the second country, a first payment server of the first country, a second payment server of the second country, and a payment settlement platform server, the method comprising:
the first sales server receiving a second order from the second user device of a second user using second country's currency;
the first sales server providing, in response to the second order, a second payment amount in the second country's currency for the second user device and transmitting a second payment request to a second payment server;
the second sales server receiving a first order from the first user device of a first user using first country's currency;
the second sales server providing, in response to the first order, a first payment amount in the first country's currency for the first user device and transmitting a first payment request including the first payment amount to a first payment server;
the first payment server receiving the first payment request from the second sales server, generating a first transaction information including the first payment amount, and transmitting the first transaction information to the payment settlement platform server;
the second payment server receiving the second payment request from the first sales server, generating a second transaction information including the second payment amount, and transmitting the second transaction information to the payment settlement platform server;
the payment settlement platform server receiving the first and second transaction information from the first and second payment server respectively, generating a balance information including balance between the first payment amount and second payment amount, transmitting the second transaction information and the balance information to the first payment server, and transmitting the first transaction and the balance information to the second payment server, wherein the balance information is calculated based on a currency exchange rate between the first country's currency and the second country's currency;
the first payment server charging the first user device for the first payment amount in the first country's currency using the first transaction information and paying the first sales server the second payment in the first country's currency using the second transaction information received from the payment settlement platform server;
the second payment server charging the second user device for the second payment amount in the second country's currency using the second transaction information and paying the second sales server the second payment in the second country's currency using the first transaction information received from the payment settlement platform server; and
the first payment server and second payment server settling the balance through the a payment settlement platform server.

3. A system for settling payment for overseas purchase comprising:
a first user device of a first user of a first country using a first country's currency;
a second user device of a second user of a second country using a second country's currency;
a first sales server of the first country configured to provide, in response to a second order from the second user device, a second payment amount in the second currency for the second user device and generating a second payment request including the second payment amount;
a second sales server of the second country configured to provide, in response to a first order from the first user device, a first payment amount in the first currency for the first user device and generating a first payment request including the first payment amount;
a first payment server of the first country configured to receive the second payment request from the first sales server and generate a second transaction information including at least the second payment amount;
a second payment server of the second country configured to receive the first payment request from the second sales server and generate a first transaction information including at least the first payment amount; and
a payment settlement platform server configured to receive the first and second transaction information respectively from the first and second payment server, generate a settlement information including balance between the first payment amount and second payment amount, transmit the first transaction information and the balance information to the first payment server, and transmit the second transaction and the balance information to the second payment server, wherein the balance calculated based on a currency exchange rate between the first currency and the second currency;
wherein the first payment server charges the first user device for the first payment amount in the first currency using the first transaction information received from the payment settlement platform server and pays the first sales server the second payment in the first currency using the second transaction information,
wherein the second payment server charges the second user device for the second payment amount in the second currency using the second transaction information received from the payment settlement platform server and pays the second sales server the first payment in the second currency using the first transaction information, and
wherein the first payment server and second payment server settle the balance through the a payment settlement platform server.

4. A method for settling payment for overseas purchase, the method is performed by a network system comprising a first user device of a first country, a second user device of a second country, a first sales server of the first country, a second sales server of the second country, a first payment server of the first country, a second payment server of the second country, and a payment settlement platform server, the method comprising:
the first sales server receiving a second order from the second user device of a second user using second country's currency;
the first sales server providing, in response to the second order, a second payment amount in the second country's currency for the second user device and transmitting a second payment request to a second payment server;
the second sales server receiving a first order from the first user device of a first user using first country's currency;
the second sales server providing, in response to the first order, a first payment amount in the first country's currency for the first user device and transmitting a first payment request including the first payment amount to a first payment server;
the first payment server receiving the second payment request from the first sales server, generating a second transaction information including the second payment amount, and transmitting the first transaction information to a payment settlement platform server;
the second payment server receiving the first payment request from the second sales server, generating a first transaction information including the first payment amount, and transmitting the first transaction information to a payment settlement platform server;
the payment settlement platform server receiving the first and second transaction information from the first and second payment server respectively, generating a settlement information including balance between the first payment amount and second payment amount, transmitting the first transaction information and the balance information to the first payment server, and transmitting the second transaction information and the balance information to the second payment server, wherein the balance is calculated based on a currency exchange rate between the first country's currency and the second country's currency;
the first payment server charging the first user device for the first payment amount in the first country's currency using the first transaction information received from the payment settlement platform server, and paying the first sales server the second payment in the first country's currency using the second transaction information;
the second payment server charging the second user device for the second payment amount in the second country's currency using the second transaction information received from the payment settlement platform server, and paying the second sales server the second payment in the second country's currency using the first transaction information; and
the first payment server and second payment server settling the balance through the a payment settlement platform server.

5. A payment settlement platform server, comprising:
a transaction information receiving module configured to receive first transaction information including a first payment amount and second transaction information including a second payment amount from a first payment server and a second payment server, respectively, wherein the first payment server and the second payment server, respectively, belong to a first payment agency of a first country and a second payment agency of a second country;
a payment settlement information generating module configured to generate settlement information including a balance between the first payment amount and the second payment amount based on the first and second transaction information, wherein the balance is calculated based on an exchange rate between a first currency and a second currency; and
a settlement information transmitting module configured to transmit the first transaction information and the settlement information to the first payment server and transmit the second transaction information and the settlement information to the second payment server.

6. The payment settlement platform server of claim 5, wherein the first payment amount corresponds to a price of a first product, the first product purchased from a second sales server using the second currency by a first user device using the first currency, and the first payment amount is requested, by the second sales server, to be approved by the second payment server.

7. The payment settlement platform server of claim 5, wherein the second payment amount corresponds to a price of a second product, the second product purchased from a first sales server using the first currency by a second user device using the second currency, and the second payment amount is requested, by the first sales server, to be approved by the first payment server.

8. A payment settlement platform server, comprising:
a transaction information receiving module configured to receive first transaction information including a first payment amount and second transaction information including a second payment amount from a first payment server and a second payment server, respectively, wherein the first payment server and the second payment server, respectively, belong to a first payment agency of a first country and a second payment agency of a second country;
a payment settlement information generating module configured to generate settlement information including a balance between the first payment amount and the second payment amount based on the first and second transaction information, wherein the balance is calculated based on an exchange rate between a first currency and a second currency; and
a settlement information transmitting module configured to transmit the first transaction information and the settlement information to the second payment server and transmit the second transaction information and the settlement information to the first payment server.

9. The payment settlement platform server of claim 8, wherein the first payment amount corresponds to a price of a first product, the first product purchased from a second sales server using the second currency by a first user device using the first currency, and the first payment amount is requested, by the second sales server, to be approved by the first payment server.

10. The payment settlement platform server of claim 8, wherein the second payment amount corresponds to a price of a second product, the second product purchased from a first sales server using the first currency by a second user device using the second currency, and the second payment amount is requested, by the first sales server, to be approved by the second payment server.

11. A system for settling payment for overseas purchase comprising:
a first user device of a first user using a first country's currency:
a second user device of a second user using a second country's currency:
a first sales server configured to provide, in response to a second purchase order received from the second user device, a second payment amount in the second country's currency for the second user device, wherein the first sales server belongs a first merchant using the first country's currency;
a second sales server configured to provide, in response to a first order received from the first user device, a first payment amount in the first country's currency for the first device, wherein the second sales server belongs a second merchant using the second country's currency;
a first payment server of the first country configured to receive a first payment request including the second payment from the first user device, charge the first user device for a first payment amount in the first country's currency in response to the first payment request, generate a first transaction information including the first payment amount, and transmit the first transaction information to a payment settlement platform server;
a second payment server of the second country configured to receive a second payment request including the second payment from the second user device, charge the second user device for a second payment amount in the second country's currency in response to the second payment request, generate a second transaction information including the second payment amount, and transmit the second transaction information to a payment settlement platform server; and
a payment settlement platform server configured to receive the first and second transaction information, respectively, from first the and second payment server, generate a balance information including balance between the first payment amount and second payment amount, transmit the second transaction information and the balance information to the first payment server, and transmit the first transaction and the balance information to the second payment server, wherein the balance information is calculated based on a currency exchange rate between the first country's currency and the second country's currency,
wherein the first payment server pays the first sales server the second payment in the first country's currency using the second transaction information,
wherein the second payment server pays the second sales server the first payment in the second country's currency using the first transaction information, and
wherein the first payment server and second payment server settle the balance through the a payment settlement platform server.

12. A method for settling payment for overseas purchase, the method is performed by a network system comprising a first user device of a first country, a second user device of a second country, a first sales server of the first country, a second sales server of the second country, a first payment server of the first country, a second payment server of the second country, and a payment settlement platform server, the method comprising:
the first sales server receiving a second order from the second user device of a second user using second country's currency;
the first sales server providing, in response to the second order, a second payment amount in the second country's currency for the second user device;
a second sales server receiving a first order from the first user device of a first user using first country's currency;
the second sales server providing, in response to the first order, a first payment amount in the first country's currency for the first user device;
the first payment server charging the first user device for a first payment amount in the first country's currency in response to a first payment request, including the first payment, transmitted from the first user device, generating a first transaction information including the first payment amount, and transmitting the first transaction information to a payment settlement platform server;
the second payment server charging the second user device for a second payment amount in the second country's currency in response to a second payment request, including the second payment, transmitted from the first user device, generating a second transaction information including the second payment amount, and transmitting the second transaction information to a payment settlement platform server;
the payment settlement platform server receiving the first and second transaction information from the first and second payment server respectively, generating a balance information including balance between the first payment amount and second payment amount, transmitting the second transaction information and the balance information to the first payment server, and transmitting the first transaction and the balance information to the second payment server, wherein the balance information is calculated based on a currency exchange rate between the first country's currency and the second country's currency;
the first payment server paying the first sales server the second payment in the first country's currency using the second transaction information;
the second payment server paying the second sales server the second payment in the second country's currency using the first transaction information; and
the first payment server and second payment server settling the balance through the a payment settlement platform server.
